(19) United States
(12) Patent Application Publication
(10) Pub. No.: US 2008/0005268 A1
(43) Pub. Date: Jan. 3, 2008

(54) Providing ad serving entity attribution and/or solicitation messages for call-on-select listings, such as for calls placed via call-on-select free listings

(76) Inventor: Johnny Chen, Mountain View, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/479,150

(22) Filed: Jun. 30, 2006

(51) Int. Cl. G06F 15/16

(52) U.S. Cl. 709/217

(57) ABSTRACT

A listing serving network, such as one that serves listings with call-on-select functionality, is promoted via messages. The messages might be delivered before establishment of a call (e.g., a call invoked from a selection of a call-on-select listing), during an established call, or after a call. The messages might provide call attribution to the listing serving network. The message might include an enhanced listing solicitation.

### §1. BACKGROUND OF THE INVENTION

§1.1 Field of the Invention

The present invention concerns advertisements (“ads”), such as ads served in an online environment. In particular, the present invention concerns promoting the adoption of ads (also referred to as “enhanced listings”) having so-called “call-on-select” functionality.

§1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword relevant advertising has been used by search engines, such as the AdWords advertising system by Google of Mountain View, Calif. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors, and U.S. Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. The AdSense system by Google is an example of a content-relevant advertising system.

Unfortunately for online ad delivery businesses, it has been challenging to get local establishments and small businesses to advertise online. Local establishments and small businesses may be reluctant to advertise online for a number of reasons. First, they might not want to devote resources to yet another advertising channel. Second, they might not be interested in developing an online presence. Even if they are interested, they might not have the skills to develop an online presence. Third, people often want to talk with someone at a local establishment or small business (e.g., to order a pizza, make a reservation at a local restaurant, get a plumber, arrange for car-towing, get a cost estimate, make an appointment, etc.). In general, although searching the World Wide Web (simply referred to as “the Web” below) with a personal computer is often very useful for learning about businesses, and although some Websites facilitate communications (e.g., email) with an establishment, textual communications over the Web is often not the ideal medium for users to communicate with local establishments.

Some mobile phone service providers have offered 411 services and concierge services. For example using a concierge service provided by Sprint, a user can ask an operator for a plumber in Palo Alto, and the operator finds the requested information for the user. Unfortunately, from the user's perspective, there may be fees associated with such services. From the service provider's perspective, ensuring helpful and courteous service may require recruiting, training, and retaining high-quality employees.

At least in part to address these perceived shortcomings of online advertising by local establishments are addressed by U.S. patent application Ser. No. 11/026,507 (incorporated herein by reference and referred to as “the '507 application), titled “GENERATING AND/OR SERVING LOCAL AREA ADVERTISEMENTS, SUCH AS ADVERTISEMENTS FOR DEVICES WITH CALL FUNCTIONALITY,” filed on Dec. 30, 2004 and listing Shumeet Baluja and Henry A. Rowley, as inventors. The '507 application describes how ads might be generated from listings, such as Yellow Page directory listings. Techniques described in the '507 application permit local establishments to quickly and effectively advertise online. These types of ads are especially valuable for queries performed on mobile phones, which will most likely be the type for which an immediate (and many times local) response is required (e.g., where to eat dinner, where to order a pizza, where is the nearest service station, which plumber to call, etc.).

Unfortunately, there may be many businesses that are reluctant to advertise with a call-on-select ad or listing serving network because they may be skeptical of the ability of such a network to bring them customers and/or leads, or because they are simply unaware of such a network. Even businesses that do advertise with a call-on-select ad or listing serving network might not appreciate the number of customers and/or leads being driven to them by the network.

In view of the foregoing, it would be useful to provide means for effectively helping to increase awareness of the utility of call-on-select ad serving networks to various businesses.

### §2. SUMMARY OF THE INVENTION

Embodiments consistent with the present invention may be used to promote a listing serving network, such as one that serves listings with call-on-select functionality, via messages. The messages might be delivered before establishment of a call (e.g., a call invoked from a selection of a call-on-select listing), during an established call, or after a call. The messages might provide call attribution to the listing serving network. The message might include an enhanced listing solicitation.

Some embodiments consistent with the present invention may promote a listing serving network by (a) accepting a query from a client device, (b) determining a set of zero or more enhanced listings using at least information in the query, (c) determining a set of one or more non-enhanced listings using at least information in the query, at least one of the one or more non-enhanced listings including call-on-select code, (d) serving the determined sets of zero or more enhanced listings and one or more non-enhanced listings to the client device, (e) accepting a user selection of one of the non-enhanced listings, wherein a call between the user and a party associated with the non-enhanced listing is established responsive to the accepted user selection, and (f) providing listing network promotional message to the party associated with the selected non-enhanced listing.

In some embodiments consistent with the present invention, the non-enhanced listings need not include call-on-select functionality. Such embodiments consistent with the present invention may promote a listing serving network by (a) accepting a query from a client device, (b) determining a set of zero or more enhanced listings using at least information in the query, (c) determining a set of one or more non-enhanced listings using at least information in the query, at least one of the one or more non-enhanced listings including a special telephone number through which an listing serving entity or an affiliate of the listing serving entity might connect a calling user-end client device and a business-end client device of the business associated with the listing, (d) serving the determined sets of zero or more enhanced listings and one or more non-enhanced listings to the client device, (e) accepting an indication of a user-end client device call to the special telephone number, wherein a call between the user and a party associated with the non-enhanced listing is established responsive to the accepted user-end client device call, and (f) providing a listing network promotional message to the party associated with the selected non-enhanced listing.

Other embodiments consistent with the present invention promote a listing serving network in other ways.

### §3. BRIEF DESCRIPTION OF THE DRAWINGS

FIG. 1 is a high-level diagram showing parties or entities that can interact with an advertising system.

FIG. 2 is a diagram illustrating an environment in which, or with which, the present invention may operate.

FIG. 3 is a flow diagram of an exemplary method for helping to increase awareness of the utility of call-on-select ad serving networks to various businesses, in a manner consistent with the present invention.

FIG. 4 is a messaging diagram illustrating communications between various components in an exemplary system consistent with the present invention.

FIG. 5 illustrates an exemplary display screen, consistent with the present invention, including enhanced listings and normal listings.

FIGS. 6-10 are exemplary listings consistent with the present invention.

FIG. 11 is a block diagram of an exemplary apparatus that may perform various operations and store information used and/or generated by such operations, in a manner consistent with the present invention.

FIGS. 12 and 13 are diagrams of a mobile telephone with which embodiments consistent with the present invention may be used.

### §4. DETAILED DESCRIPTION

The present invention may involve novel methods, apparatus, message formats, and/or data structures for helping to increase awareness of the utility of call-on-select ad serving networks to various businesses. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. In the following, “information” may refer to the actual information, or a pointer to, or a location of, such information. Thus, the present invention is not intended to be limited to the embodiments shown and the inventors regard their invention to include any patentable subject matter described.

In the following definitions of terms that may be used in the specification are provided in §4.1. Then, environments in which, or with which, the present invention may operate are described in §4.2. Exemplary embodiments of the present invention are described in §4.3. Finally, some conclusions regarding the present invention are set forth in §4.4.

### §4.1 Definitions

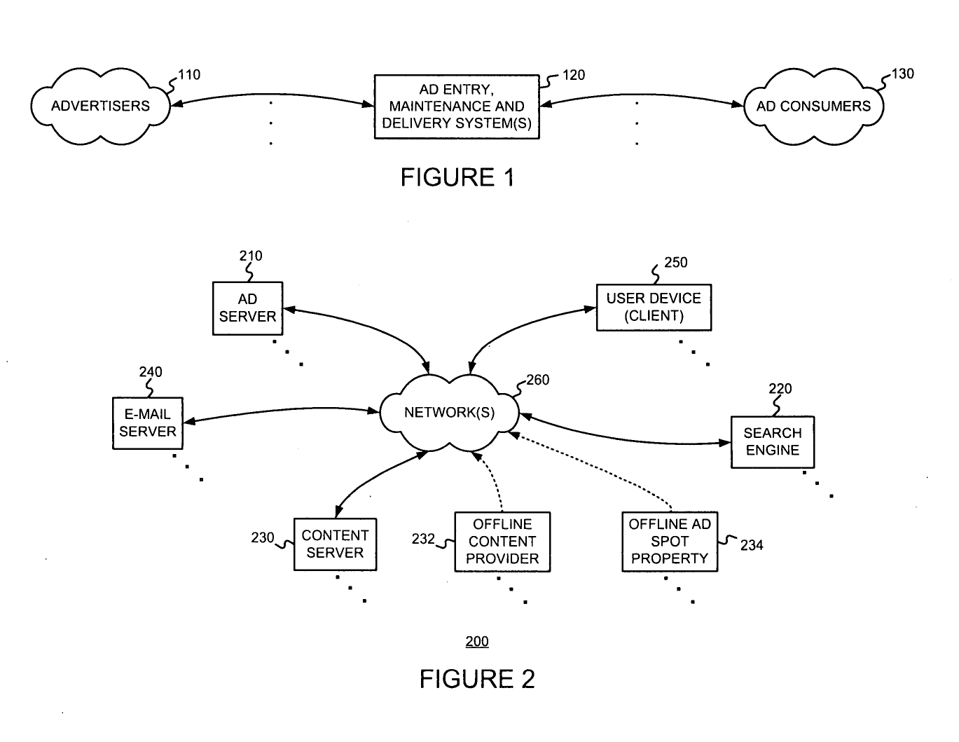

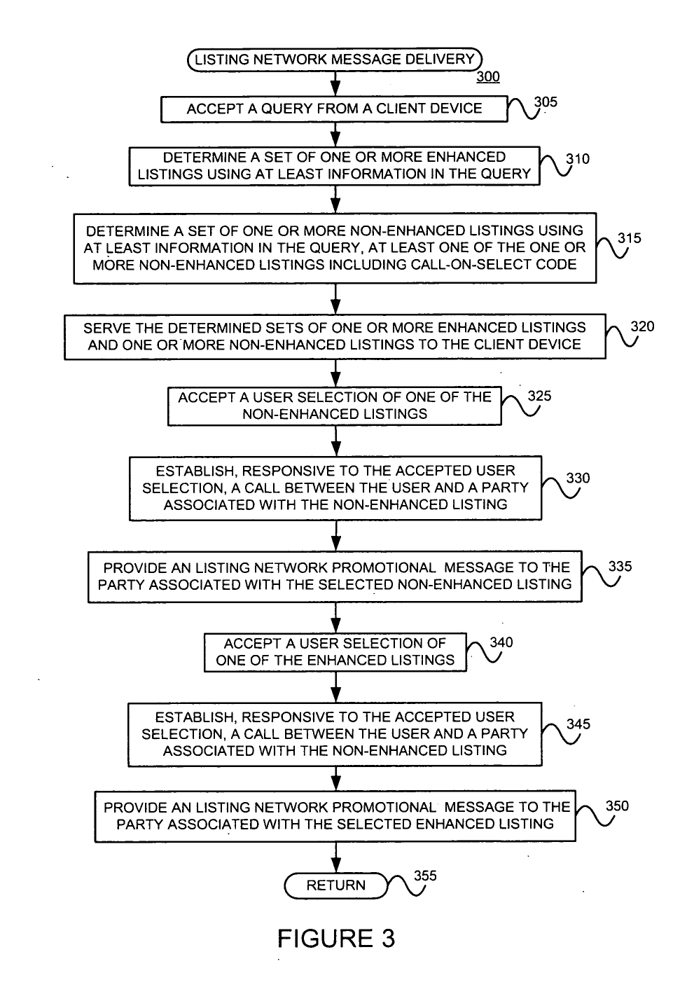

Online ads (e.g., listings, or enhanced listings), such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc. For example, a listing with call-on-select functionality might include code to facilitate the placement of a call if the listing, or an element thereof, is selected.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). Targeting criteria can be broad or narrow. For example, in some systems, an advertiser may be able to narrow the targeting of the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., click-throughs, call-throughs, etc.) of an ad to the number of impressions of the ad (i.e., the number of times an ad is rendered) is defined as the “selection rate” (or “click-through rate” or “call-through rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, spending at least a predetermined amount of time on a telephone call, making a reservation, making an appointment, placing a telephone order, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page. A Website may include multiple Web pages.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

A “listing network promotional message” may be any message in any form that promotes a network (or entity) that serves listings. If the listing network provides call-on-select listings, a listing network promotional message might include a “call attribution message” for informing at least one of the called parties of the fact that the listing network facilitated the call. A listing network promotional message might include an “enhanced listing solicitation message” encouraging a recipient to participate in (sign up for) enhanced listings. Other types of listing network promotional messages are possible.

### §4.2 Exemplary Advertising Enviroments in which, or with which, Embodiments Consistent with the Present Invention May Operate

FIG. 1 is a diagram of an advertising environment in which, or with which, embodiments consistent with the present invention may operate. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which embodiments consistent with the present invention may be used. A user device (also referred to as a “client”, “client device”, “user-end client device”, etc.) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). As one example, a search engine 220 may permit user devices 250 to search listings, such as local directory listings for example. A content server 230 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

51 Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

Embodiments consistent with the present invention might be used in various environments which will be apparent to those skilled in the art. For example, embodiments consistent with the present invention might be used in an environment in which a search engine serves listings, such as local directory listings for example.

### §4.3 Exemplary Embodiments

### §4.3.1 Exemplary Methods

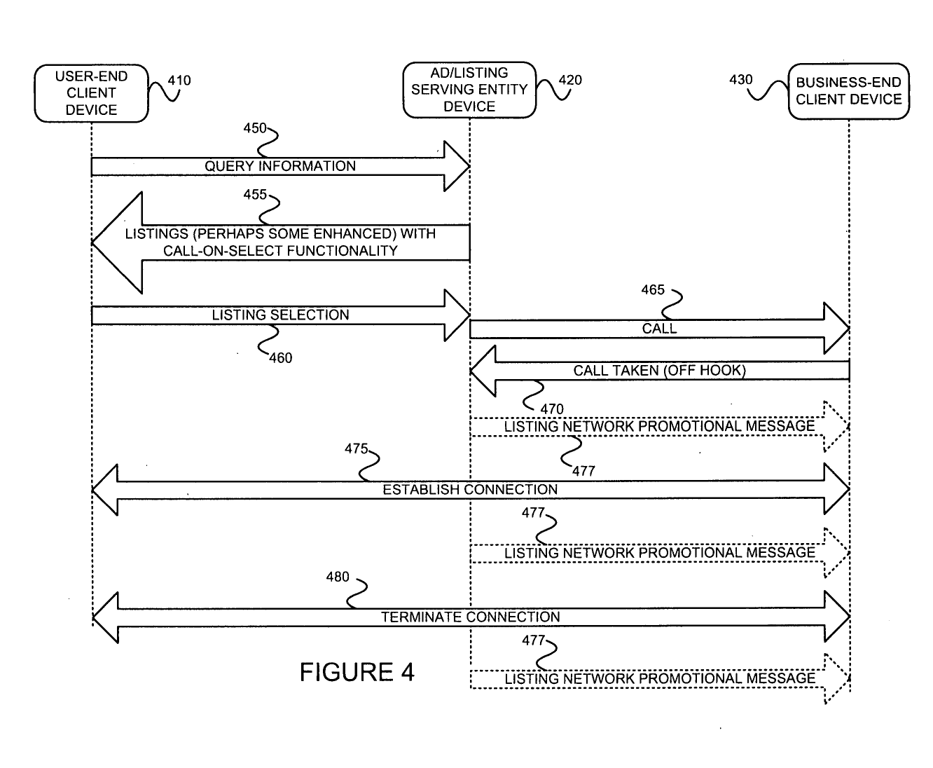

FIG. 3 is a flow diagram of an exemplary method 300 for helping to increase awareness of the utility of call-on-select ad serving networks to various businesses, in a manner consistent with the present invention. The method 300 might accept a query from a user-end client device. (Block 305) A set of one or more enhanced listings might then be determined using at least information in the query. (Block 310) Similarly, a set of one or more non-enhanced listings might be determined using at least information in the query. (Block 315) At least one of the non-enhanced listing(s) might include call-on-select code. The determined sets of one or more enhanced listings and one or more non-enhanced listings might then be served to the user-end client device. (Block 320)

In the following, it is assumed that a user at the user-end client device selected a call-on-select element of one of the non-enhanced (e.g., normal) listings. The user selection of the non-enhanced listings might be accepted. (Block 325) Responsive to the accepted user selection, a call between the user-end client device and a party associated with the non-enhanced listing (e.g. a business-end client device) is attempted to be established. (Block 330) In the following, it is assumed that the call is established. A listing network promotional message (e.g., a call attribution message and/or an enhanced listing solicitation message) might be provided to the party associated with the selected non-enhanced listing. (Block 335)

A user might select one of the enhanced listings. If so, the user selection of the enhanced listing is accepted. (Block 340) A call between the user and the party associated with the enhanced listing might then be established responsive to the accepted user selection. (Block 345) A listing network promotional message might then be provided to the party associated with the selected enhanced listing. (Block 350) In this case, since the party already has an enhanced listing, the listing network promotional message might simply be a call attribution message, which serves as a reminder to the party that it is receiving calls due to its enhanced listing (e.g., “Google listing originated call”). The listing network promotional message might be a periodic message, delivered by any one of various means such as mail, email, telephone, etc., informing the party of performance statistics of its enhanced listing (e.g., “Your enhanced listing generated 55 calls last week.”).

In some embodiments consistent with the present invention, the listing network promotional message is provided during the established call. In other embodiments consistent with the present invention, the listing network promotional message is provided before the call is established. For example, establishing the call might include (1) establishing a first portion of the call between an entity (e.g., a listing serving entity or affiliate) and the party, and (2) establishing a second portion of the call between the entity and the user-end client device, such that the call is established between the party and the user-end client device. In this case, the listing network promotional message might be provided after the first portion of the call is established but before the second portion of the call is established.

In other embodiments consistent with the present invention, the listing network promotional message is provided after the established call is terminated. The listing network promotional message might be delivered to the party via email, via a subsequent call, via printed mail, etc. It should be understood that multiple messages of one or more type might be provided to the party.

In some embodiments consistent with the present invention, the listing network promotional message might identify an entity that determined the set of one or more enhanced listings, and the set of one or more non-enhanced listings. This might be referred to as a “call attribution” message. Alternatively, or in addition, the listing network promotional message might inform the party of how they can have enhanced listings served. This might be referred to as an “enhanced listing solicitation” message.

Although not shown in FIG. 3, serving of listings and/or user selections of listings may be tracked. Performance information (e.g., click-through rates, call-through rates, etc.) might be tracked. Other information such as whether or not the call was established, length of the call, time of day of the call, etc. might be tracked. In some embodiments consistent with the present invention, at least some of this tracked information might be provided in a listing network promotional message.

Referring back to blocks 305, 310 and 315, some embodiments consistent with the present invention need not process queries for client devices to determine the sets of listings. Such embodiments might (i) provide sets of one or more enhanced listings and one or more non-enhanced listings to a user-end client device, at least one of the non-enhanced listings including call-on-select code, (ii) accept user selections of the non-enhanced listings, (iii) establish, responsive to the accepted user selections, calls between the users and parties associated with the non-enhanced listings, and (iv) provide a listing network promotional message to the party associated with the non-enhanced listing. The listing network promotional message might occur during (or just prior to) the call and inform the party that the call was due to the listing. (“This call brought to you by Google listings.”) The message might include tracked performance information (e.g., a call-through rate). The message might include a solicitation for the party to obtain an enhanced listing. (“Google listings brought you 15 calls over the last month. Try enhanced listings from Google it you want even more calls.”) If the call occurs outside the established call between the user-end client device and the party, the call might include an easy way for the party to sign up for enhanced listings. (“This call brought to you by Google listings. Press star to learn about getting more calls using Google's enhanced listings.”)

Note that some of the acts of the method 300 were performed assuming a user selection of a non-enhanced listing, while others were performance assuming a user selection of an enhanced listing. Some embodiments consistent with the present invention might perform only one of the two.

As can be appreciated from the foregoing, some embodiments consistent with the present invention might only perform a subset of the acts of the method 300.

### §4.3.2 Exemplary Component Communications

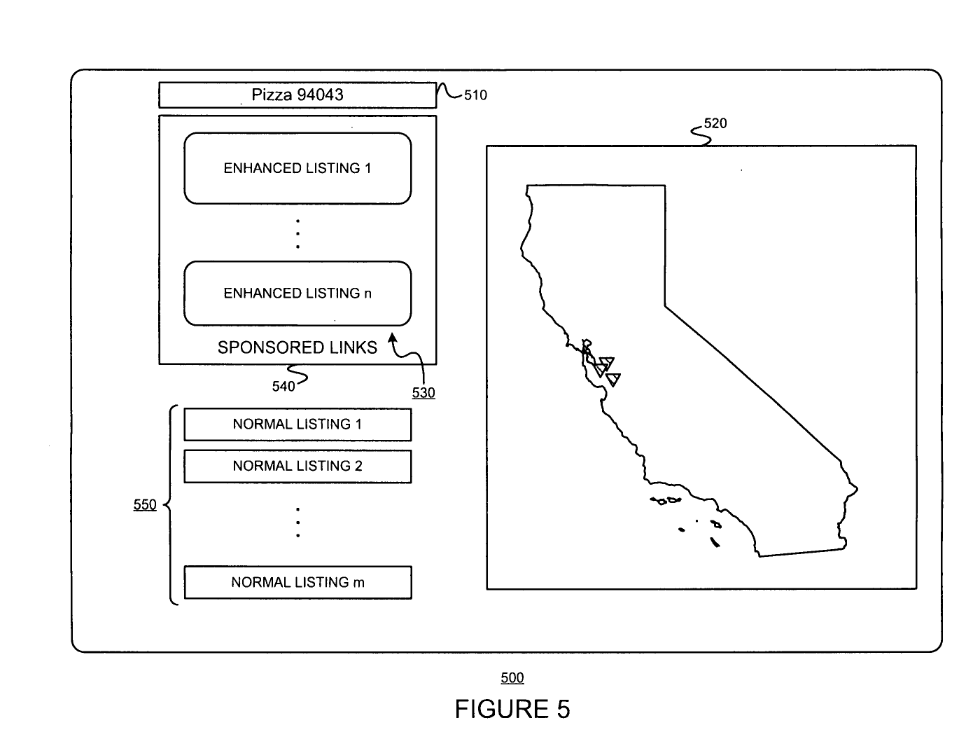

FIG. 4 is a messaging diagram illustrating communications between various components in an exemplary system consistent with the present invention. The exemplary system might include a user-end client device 410, an ad or listing serving entity device 420, and a business-end client device 430. The a user-end client device 410 and a business-end client device (e.g., server(s)) 430 should each support calls. The calls might be supported over the Internet using Voice-over-Internet Protocol (VoIP) technology, over telephone system infrastructure (e.g., the plain-old telephone system (POTS), etc.

The user-end client device 410 might transmit query information to the ad/listing serving entity device 420. (Communication 450) The ad/listing serving entity device 420 might then determine a set of one or more listings. (Recall, e.g., block 330 of FIG. 3.) The ad/listing serving entity device 320 might then provide the determined listing(s) back to the user-end client device 410. (Communication 455). If a user selects a call-on-select element of a listing, an indication of the listing selection might be sent back to the ad/listing serving entity device 420 (or an affiliate). (Communication 460)

In response to learning of the selection, the ad/listing serving entity device 420 (or an affiliate) may try to establish a call between the user-end client device 410 and the business-end client device 430. For example, the ad/listing serving entity device 420 (or an affiliate) might call the business-end client device 430. (Communication 465) If the business-end client device 430 takes the call (e.g., off hook), this might be relayed back to the ad/listing serving entity device 420 (or an affiliate). (Communication 470) The ad/listing serving entity device 420 (or an affiliate) might then establish a call between the user-end client device 410 and the business-end client device 430 as indicated by 475. A listing network promotional message (e.g., a call attribution message and/or preferred listing solicitation message) 477 might be provided before (e.g., immediately after the business picks up the phone, but before connecting the call to the user), during, or after the established call 475.

Although not shown, a listing network promotional message and/or branding message might be provided to the user-side client device as well. It may be the same message as the one provided to the business-side client device, or a distinct message.

### §4.3.3 Exemplary Query Information

Referring back to block 310 of FIG. 3 and communication 450 of FIG. 4, the query information might include information used for targeting relevant listings. For example the query information might include one or more of query keywords, user-end client device type information, user-end client device geolocation information, user-end client device local time of day information, etc.

User-end client device type information might be used to determine one or more of (i) whether or not the user device has a small display, and/or a size of the display, (ii) whether or not the user device has a low resolution display, and/or the resolution of the display, (iii) whether or not the user device has a limited communications connection, and/or a speed of the connection (which may instead be inferred), (iv) whether or not the user device has a slow processor, and/or the speed of the processor, (v) whether or not the user device is limited in terms of loading and rendering a Web page, (vi) whether or not the user device has call functionality, (vii) whether or not the user device has supports various authoring languages (e.g., a HTML, SGML, XML, WAP, WAP 2.0, dHTML, xHTML, Java, Javascript, etc.), (viii) whether the user device is supporting a currently active (not terminated) telephone call, (ix) whether or not the user device has a limited user input, (x) what type of user input is provided (e.g., touch screen, stylus, limited keypad, full keyboard, pointers, etc.), etc. Such user device information might be used in a determination of whether or not to serve certain ads or certain types of listings, and/or how to score competing listings.

User-end client device “geolocation information” might include information specifying one or more of one or more countries, one or more (inter-country) regions, one or more states, one or more metro areas, one or more cities, one or more towns, one or more boroughs, one or more areas with common zip codes, one or more areas with common telephone area codes, one or more areas served by common cable head end stations, one or more areas served by common network access points or nodes, etc. It might include latitude and/or longitude, or a range thereof. It might include information, such as an IP address, from which a user location can be estimated.

User-end client device geolocation information might be encoded in various ways. For example, a country identifier may be a two character code such as those determined by the International Organization for Standardization (“ISO”). The region identifier might be a six character code such as those determined by UTF8. Thus, the country and region might be encoded using the ISO 3166-2/1999 standard which is a two letter country code followed by a “-” and 1-3 alphanumeric characters. The ISO 3166-2/1999 standard code might be mapped to a numerical identifier (e.g., in the range of 20001-30000). New regions might be assigned a numerical identifier appended to the end. In one embodiment consistent with of the present invention, more than 200 countries and 1300 regions are uniquely identified. The metro area identifier might be based on the DMA standard. In one embodiment consistent with the present invention, metro areas can cross state lines. Accordingly, in such an embodiment, a metro area is not necessarily “contained” within a state. Since the same city or town name can be used for different cities or towns in different states, such information should be used in combination with state information to avoid ambiguity. Postal zip codes might be encoded as a 5-digit integer, or extended with 4 or more digits. Telephone area codes might be encoded as a three-digit integer. Other ways of encoding geolocation information are possible.

User-end client device geolocation information might be derived or estimated from other information. For example, if the user-end client device is a mobile telephone with GPS functionality, its geolocation might be provided by components in the mobile telephone that provide GPS functionality. As another example, known techniques (such as that used by the “NetAcuity” product from Digital Envoy of Norcross, GA) to map Internet protocol (“IP”) address and/or domain information to geolocation information. As another example, Internet service providers might have many dial-in access servers, each associated with a telephone area code. As yet another example, a location might be inferred from a regional term (e.g., hoagie, hero, grinder, sub) entered into the user-end client device. If multiple factors are used to infer geolocation, but lead to inconsistent locations, each without a desired level of confidence, a more general, consistent location, might be used. Alternatively, previously derived or provided geolocation information might be accepted. For example, the user-end client device might be a fixed terminal, such as a kiosk at a mall or transportation terminal.

Although some examples above used geolocation information as a current location of the user-end client device, the geolocation information may be a location that the user is interested in.

### §4.3.4 Exemplary Listings

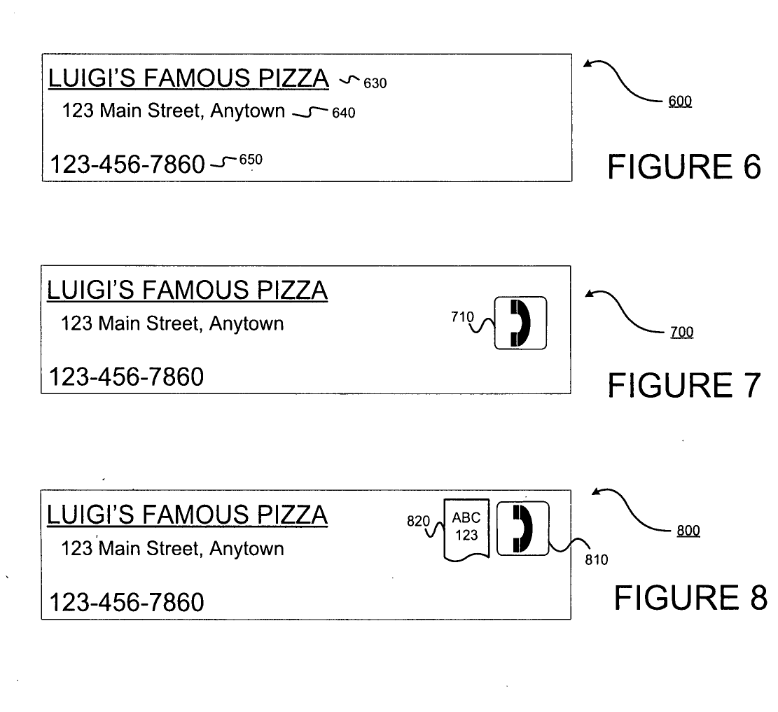

FIG. 5 illustrates an exemplary display screen 500, consistent with the present invention, including enhanced listings and normal listings. As shown, the exemplary display screen 500 might include a text query entry element 510, a map element 520, a set of one or more enhanced listings 530, and/or a set of one or more non-enhanced (or “normal”) listings 550.

Locations corresponding to at least some of the enhanced listings 530 and/or normal listings 550 might be indicated on the map element 520 as indicated by the inverted triangles. The query to which the listing(s) were responsive (e.g., “pizza 94043”) might be displayed in query entry element 510. Notice that enhanced listing(s) 530 might be provided in a preferred position (e.g., above) with respect to the normal listing(s) 550. The enhanced listing(s) 530 might be identified as “Sponsored Links” 540.

The '507 application describes techniques for generating local online ad information. Such techniques might be used to generate listings. Alternatively, the listing might have been previously generating using known and/or proprietary techniques. The listings might include one or more of

business name;

address;

phone number; and

business-type listing (e.g., is it listed under “plumbers” or “painters” or “restaurant”, etc.). One or more additional fields such as graphics (e.g., logos, etc.), business hours, associated descriptive text, payment methods (e.g., VISA, MasterCard, American Express, Bank Check, etc.), etc. might also be provided.

In some embodiments consistent with the present invention, enhanced listings include one or more features or elements (e.g., logos, business hours, additional descriptive text, payment methods, etc.) not included in normal listings. Generally, for a given business, an enhanced listing will generate more desired results (e.g., more conversions, more calls, etc.) than a non-enhanced listing. Note that a non-enhanced listing might include elements deemed to be enhancements, but will not include one or more enhancements found in enhanced listings. Accordingly, non-enhanced listings might only be considered “non-enhanced” relative to enhanced listings.

For simplicity, the business-type listing, business name, business location, associated descriptive text, etc., can be used as the “keywords” which are used specify what a listing pertains to. These keywords might be used to determine whether or not a listing is relevant to query information.

As with many ads of online advertising systems, one or more listings may be displayed in association with a document, such as a search results page, or a Webpage with content for example. Typically, online ads include embedded information (e.g., links) such that when the ad is selected (e.g., by a user clicking on the ad), a browser is loaded with a document (e.g., a Webpage) associated with the ad. Such a document is commonly referred to as the “landing page” of the ad. A listing (e.g., an enhanced listing) might include similar embedded information.

In some embodiments consistent with the present invention, at least some listings might include call-on-select (e.g., click-to-call, or CTC) elements. When such an element is selected, a call is attempted to be established between a user-end client device and a business-end client device. Even non-enhanced or normal listings might include call-on-select functionality. Alternatively, such listings might simply include a special telephone number (perhaps toll free) through which an ad/listing serving entity (or an affiliate) might connect a calling user-end client device and a business-end client device of the business associated with the listing. In this way, the ad/listing serving entity (or an affiliate) can still provide listing network promotional messages. Further, business with normal listings might be encouraged to sign up for enhanced listings if one of the enhanced features is call-on-select functionality.

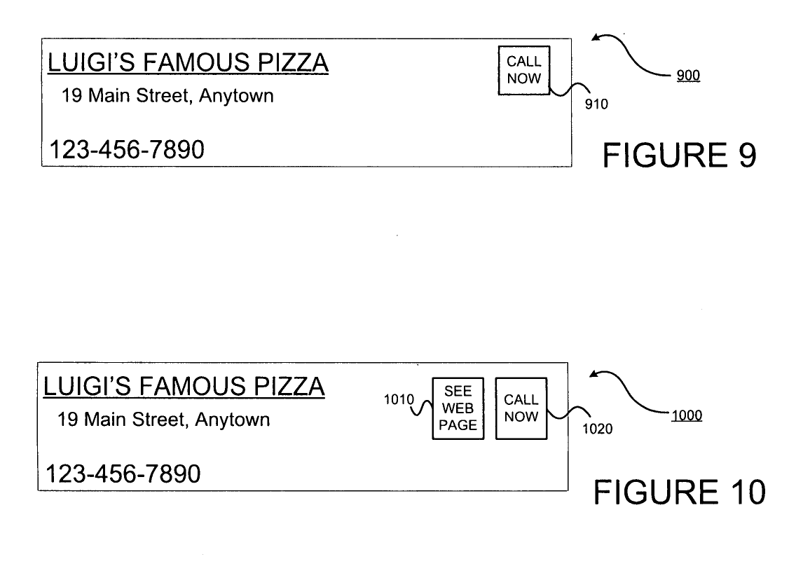

FIGS. 6-10 are exemplary listing displays (simply referred to as “listings”) consistent with the present invention. FIG. 6 is a text listing 600 which might include one or more of an establishment name line 630, an establishment address 640 and an establishment telephone number 650. Other information might be used instead of, or in addition to, such information. Typically, when such listing is selected by a user clicking on the ad, an associated Web page is loaded onto the user's browser. However, this may not be desirable for certain user devices. Thus, in at least some embodiments consistent with the present invention, selecting the ad may initiate a telephone call to the establishment. The listing 600 might include a special telephone number (perhaps toll free) through which an ad/listing serving entity (or an affiliate) might connect a calling user-end client device and a business-end client device of the business associated with the listing.

FIG. 7 is a text listing 700 which includes call-on-select functionality as indicated by icon button 710. In some embodiments consistent with the present invention, a call (to a telephone number associated with the ad) is initiated when the icon button 710 is selected (e.g., via touch screen, stylus, keystroke, pointer, such as a joystick, a touchpad, a track call, etc.). Depending on the embodiment, if a portion of the listing 700 other than the icon button 710 is selected, a call can be initiated, or, alternatively, a linked document can be rendered on the browser of the device.

FIG. 8 is a text listing 800 which includes call-on-select functionality as indicated by icon button 810, as well as linked document functionality as indicated by icon button 820. In some embodiments consistent with the present invention, a call (to a telephone number associated with the listing) is initiated when the icon button 810 is selected and a linked document is rendered on a browser of the user-end client device when the icon button 820 is selected. Depending on the embodiment, if a portion of the listing 800 other than the icons buttons 810 and 820 is selected, a call can be initiated, or, alternatively, a linked document can be rendered on the browser of the device.

FIG. 9 is a text listing 900 which includes call-on-select functionality as indicated by button 910. In some embodiments of the present invention, a call (to a telephone number associated with the listing) is initiated when the button 910 is selected. Depending on the embodiment, if a portion of the listing 900 other than the button 910 is selected, a call can be initiated, or, alternatively, a linked document can be rendered on the browser of the device.

FIG. 10 is a text listing 1000 which includes call-on-select functionality as indicated by button 1010, as well as linked document functionality as indicated by button 1020. In some embodiments of the present invention, a call (to a telephone number associated with the listing) is initiated when the button 1010 is selected and a linked document is rendered on the browser when the button 1020 is selected. Depending on the embodiment, if a portion of the listing 1000 other than the buttons 1010 and 1020 is selected, a call can be initiated, or, alternatively, a linked document can be rendered on the browser of the device.

Listings with both call and linked document functionality might have different performance parameters associated with the different functionality. Alternatively, or in addition, the listing might have different offers associated with different user actions (e.g., a first offer for a call and a second offer for a linked document referral. In some embodiments consistent with the present invention, an arbitration of eligible listings (e.g., listings relevant to the query) is used to select which listings to serve, and perhaps how to serve them. The arbitration might score the listings. The scoring of listings may consider one or more of the different performance parameters and/or one or more of the different offers.

Although text listings were shown in FIGS. 6-10, other types of listings might be used in a manner consistent with the present invention. Further, different ways of navigating to (a) loading a document and/or (b) dialing a telephone number are possible. For example, when a user selects a listing, they may be asked whether they want to visit the advertiser's Web page or talk to the advertiser.

Furthermore, the listings needn't be displayed listing. For example, the listings might be audio voice listings. Consider, for example, a “411” call requesting pizza in Mountain View, Calif. One or more “sponsored” (or paid) audio voice listings might be presented, followed by one or more normal audio voice listings. A call to a business associated with a sponsored audio voice listing (and perhaps a normal audio voice listing) might be established in response to a user input.

### §4.3.5 Serving and/or Scoring of Listings

Techniques described in the '507 application might be used to score listings, and these scores might be used to determine which listings to serve (and perhaps placement or other attribute of the listings). Other techniques might be used. Generally, the score of a listing might be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the ad (e.g., selection rate, user rating, conversion rate, etc.), (vii) location targeting information, (viii) whether the listing is enhanced or normal, etc.

A display screen, such as that 500 of FIG. 5, might have a predetermined number of listing spots, perhaps divided among enhanced listings and normal listings. As one example, the display screen might provide 3-5 enhanced listing spots, and 10 normal listing spots. Other arrangements are possible. Further, instead of having a predetermined number, the total number of listing spots, and/or the apportionment of listing spots to enhanced listings and normal listing might be a function of listing scores. For example, if all eligible (e.g., relevant) enhanced listing score below a certain threshold, all of the listing spots might be provided to normal listings.

### §4.3.6 Exemplary Listing Network Promotional Messages

As described above, listing network promotional messages might be provided in response to a call-on-select selection, before, during, or after the establishment of a call between a user-end client device and a business-end client device. If provided during (or just before) the establishment of a call, the listing network promotional message might be an audio message.

If the listing network promotional message is a call attribution message, it might convey something like, “This call brought to you by Google listings.” The content of the message might depend on whether call was from an enhance listing or a normal listing. If the call was from an enhanced listing, the message might simply include a call attribution message. If, however, the call was from a normal listing the message might include an enhanced listing solicitation message such as “Call brought to you by Google listings. Get more calls with Google enhanced listings.” Normal listings with call-on-select functionality might be provided for a limited time. In this case, the message might include an enhanced listing solicitation message such as “Call brought to you by Google call-on-select listing. Free trial ends in ______ days.”

If the listing is an enhanced listing, the message might include statistics. For example, the message might occur during the call and convey something like “This is the tenth call from Google listings-plus this today.” Alternatively, or in addition, the message might be used to “up-sell” the business to add features and/or to increase their budget. For example, an up-sell message might be “You received 100 calls this month. Increase your budget by $20.00 to get up to 100 more.”, or “You received 100 calls this month. Increase your calls with an animated logo listing.”. If the message occurs after termination of the call, the message might include more detailed and/or aggregated information. For example, the message might be an email message such as:

Google Enhanced Listings Performance Report

May 2006
255 calls
Average Time per Call: 3 minutes
Median Time per call: 85 seconds
Total Cost: $25.50
Average Cost per Call: $0.10

If the listing is a normal listing, the message might also include statistics in the context of an enhanced listing solicitation message. If the message occurs after termination of the call, the message might be an email message such as:
Your Business Received 35 calls in May from Google Listings. You can receive even more business calls with Google Enhanced Listings. Click *HERE* to find out more or to sign up.

Naturally, other messages are possible.

### §4.3.7 Exemplary Apparatus

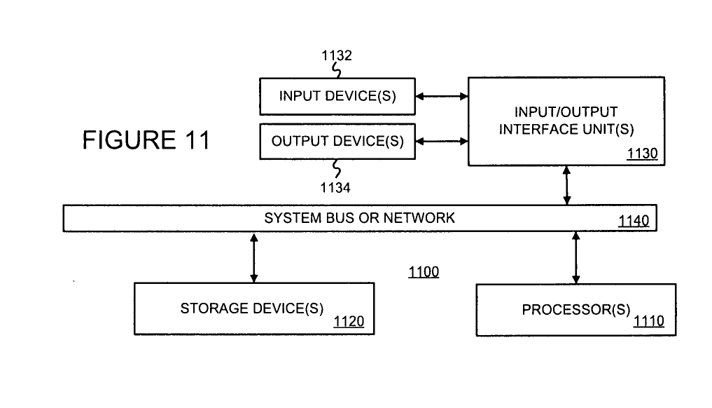

FIG. 11 is a block diagram of a machine 1100 that may perform one or more of the operations discussed above. The machine 1100 includes one or more processors 1110, one or more input/output interface units 1130, one or more storage devices 1120, and one or more system buses and/or networks 1140 for facilitating the communication of information among the coupled elements. One or more input devices 1132 and one or more output devices 1134 may be coupled with the one or more input/output interfaces 1130.

The one or more processors 1110 may execute machine-executable instructions (e.g., C or C++ running on the Solaris operating system available from Sun Microsystems Inc. of Palo Alto, Calif., the Linux operating system widely available from a number of vendors such as Red Hat, Inc. of Durham, N.C., the BREW or J2ME applications platforms, the Symbian operating system from Symbian of London, UK, Java, assembly, Perl, etc.) to effect one or more aspects of the present invention. At least a portion of the machine executable instructions may be stored (temporarily or more permanently) on the one or more storage devices 1120 and/or may be received from an external source via one or more input interface units 1130.

In one embodiment, the machine 1100 may be one or more conventional personal computers, mobile telephones, PDAs, etc. In the case of a conventional personal computer, the processing units 1110 may be one or more microprocessors. The bus 1140 may include a system bus. The storage devices 1120 may include system memory, such as read only memory (ROM) and/or random access memory (RAM). The storage devices 1120 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1132, such as a keyboard and pointing device (e.g., a mouse) for example. Other input devices such as a keypad, buttons, microphone, a joystick, a game pad, a satellite dish, a scanner, or the like, may also (or alternatively) be included. These and other input devices are often connected to the processing unit(s) 1110 through an appropriate interface 1130 coupled to the system bus 1140. The output devices 1134 may include a monitor or other type of display device, which may also be connected to the system bus 1140 via an appropriate interface. In addition to (or instead of) the monitor, the personal computer may include other (peripheral) output devices (not shown), such as speakers and printers for example.

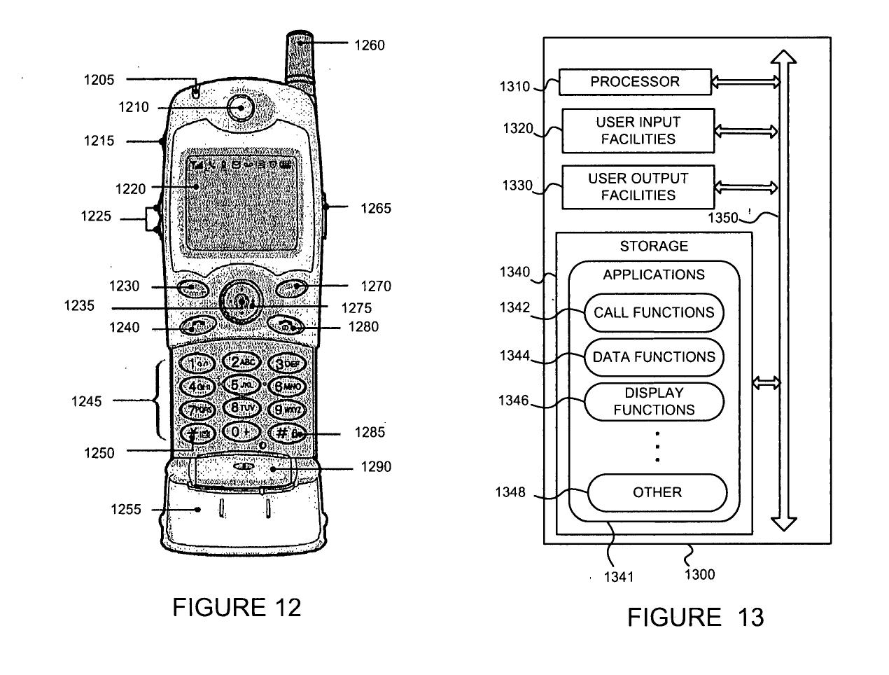

The machine 1100 may be a mobile telephone such as those 1200 and 1300 illustrated in FIGS. 12 and 13, respectively, and described below.

Referring back to FIG. 2, one or more machines 1100 may be used as ad server 210, search engine 220, content server 230, e-mail server 240, and/or user device 250. Referring back to FIG. 4, one or more machines 1100 may be used at user-end client device 410, ad/listing serving entity device 420, and/or business-end client device 430.

User-end client device 410 and business-end client device 430 should support call functionality. FIGS. 12 and 13 are diagrams of mobile telephones with which embodiments consistent with the present invention may be practiced. The mobile telephone 1200 of FIG. 12 may include one or more of a call indicator 1205, an earpiece 1210, a record key 1215, a display screen 1220, an up/down side key 1225, a soft left key 1230, an easy key 1235, a send key 1240, numeric keys 1245, a star key 1250, an active flip 1255, an antenna 1260, a hands-free connector 1265, a soft right key 1270, navigation keys 1275, an end/power key 1280, a hash or pound key 1285 and a microphone 1290.

FIG. 13 is a block diagram of a mobile telephone 1300 with which embodiments consistent with the present invention may be practiced. The mobile telephone 1300 may include one or more processors 1310, one or more user input facilities 1320 (e.g., keys and microphone), one or more user output facilities 1330 (e.g., display and speaker) and one or more storage facilities 1340. These facilities can communicate with one another via one or more buses or networks 1350. The storage facilities 1340 may include various applications 1341, such as applications that support call functions 1342, applications that support data functions 1344, applications that support display functions 1346, as well as additional applications 1348. The data functions 1344 may include browser functions. Finally application program interfaces (APIs) may be provided which allow data functions 1344 to access call functions 1342.

Currently, some telephones can extract telephone number information from short-message-service (SMS) messages (e.g., by looking for simple patterns ###-###-####, (###) ###-####, etc.). Therefore, a listing delivered in SMS can include a telephone number that will be recognized—and if selected can cause the telephone to dial the telephone number. Microsoft has already installed a feature in its pocket-PC Explorer which uses the following syntax:
<a href=“tel:12063722651”>call me</a>
   which basically puts up a link that, if pressed, calls the telephone number in the “tel:” tag.

Most phones that support data and voice modes usually include a limited amount of interaction between the data and voice sides. However, dialing from a Web page is possible by having an application on the user device use APIs, available on many mobile telephones, to dial a telephone number that is often exposed to the data side. The mobile client applications may be developed using various commercially available platforms such as Binary Runtime Environment for Wireless ((BREW) from Qualcomm of SanDiego, Calif.), Java 2 Micro Edition ((J2ME) from Sun of Santa Clara, Calif.), Symbian, Smartphone, etc., for example. BREW and J2ME allow commands, such as initiative voice-call, to be sent to applications for the voice functions of the telephone.

### §4.3.8 Alternatives and Extensions

In at least some embodiments consistent with the present invention, call-on-select ads are only served and/or have selection enabled if the telephone number is a local telephone number. Such embodiments would avoid long distance calls. This feature may be linked with a calling plan of the user device.

Not all listing links need to have telephone numbers associated with them. In at least some embodiments consistent with the present invention, the user is given an option (either before or after ad selection) of making a voice call or going to the Web page. As shown in FIGS. 8 and 10 above, separate buttons with separate links for Web page display or voice calls can be provided. Alternatively, the business can decide this. As yet another alternative, whether to display a Web page or make a voice call may be determined by pre-existing user preferences.

The telephone number can be included as data and sent in variety of forms. It does not even need to be interpreted by standard HTML browsers. It can be sent as meta data in the header of the page returned. Alternatively, or in addition, it can be sent as comments with the each advertisement. Alternatively, or in addition, it can be sent as structured data. Alternatively, or in addition, it can be sent as a “tel:XXX” tag. The first and second options are useful in cases in which the renderer is not known or under control of the ad server (for example if it is shown in a browser that does not support tel links). In such cases, the telephone call functionality may not exist and the phone number will simply be ignored. The third option is useful if a structured feed is returned to the user device. For example, search results may be returned to a mobile telephone in an XML formatted feed. Advertisements and all the related advertisement fields can also be formatted in XML (or any other structured language). The XML is treated as a data feed and the rendering is all dictated by the intelligence built into a client application on the user device.

In at least some embodiments consistent with the present invention, the call-on-select telephone number may connect the client to an audio document (e.g., a voice message) or a live operator, depending on the telephone number specified by the advertiser. Although not shown in FIGS. 6-10, different buttons can be used to indicate whether the call will be placed to an audio document or a live operator.

In at least some embodiments consistent with the invention, selecting an ad or a button on an ad may initiate both a call and a document-load. The call initiation and document-load initiation may occur in parallel or in series. In still another alternative embodiment consistent with the present invention, a limited document (e.g., in terms of time to load and render) with one or more call-on-select links can be loaded in response to an ad selection. For example, rather than load a large Web page, a limited document stating:
CLICK HERE TO PLACE A TAKE OUT ORDER
CLICK HERE TO ORDER DELIVERY
CLICK HERE TO MAKE A RESERVATION
   may be loaded. In some embodiments, limited documents are supported for enhanced listings, but not for normal listings.

Although some of the exemplary embodiments described the use of a browser, at least some embodiments consistent with the present invention may use some other content rendering application or device.

Although some of the exemplary embodiments described above established a telephone call, embodiments consistent with the present invention might establish other types of communications (e.g., text messaging, email, etc.).

### §4.4 Conclusions

As can be appreciated from the foregoing, embodiments consistent with the present invention may be used to effectively promote a listing serving network, such as one that serves listings with call-on-select functionality. The promotion might be used with existing subscribers (e.g., in order to validate their decision to subscribe). The promotion might be used with potential subscribers (e.g., in order to entice them to subscribe).

What is claimed is:

1. A computer-implemented method comprising:
a) accepting a query from a client device;
b) determining a set of zero or more enhanced listings using at least information in the query;
c) determining a set of one or more non-enhanced listings using at least information in the query, at least one of the one or more non-enhanced listings including call-on-select code;
d) serving the determined sets of zero or more enhanced listings and one or more non-enhanced listings to the client device;
e) accepting a user selection of one of the non-enhanced listings, wherein a call between the user and a party associated with the non-enhanced listing is established responsive to the accepted user selection; and
f) providing listing network promotional message to the party associated with the selected non-enhanced listing.

2. The computer-implemented method of claim 1 wherein the listing network promotional message is provided during the established call.

3. The computer-implemented method of claim 1 wherein the listing network promotional message is provided before the call is established between the user and the party.

4. The computer-implemented method of claim 1 wherein the act of establishing the call includes
establishing a first portion of the call between an entity and the party, and
establishing a second portion of the call between the entity and the user, such that the call is established between the party and the user, and
wherein the listing network promotional message is provided after the first portion of the call is established but before the second portion of the call is established.

5. The computer-implemented method of claim 1 wherein the listing network promotional message is provided after the established call is terminated.

6. The computer-implemented method of claim 5 wherein the listing network promotional message is delivered to the party via email.

7. The computer-implemented method of claim 5 wherein the listing network promotional message is delivered to the party via a subsequent call.

8. The computer-implemented method of claim 5 wherein the listing network promotional message is delivered to the party via printed mail.

9. The computer-implemented method of claim 1 wherein the listing network promotional message includes a call attribute message which identifies an entity that determined the set of one or more enhanced listings, and that determined the set of one or more non-enhanced listings.

10. The computer-implemented method of claim 1 wherein the listing network promotional message includes an enhanced listing solicitation message which informs the party of how they can have enhanced listings served.

11. The computer-implemented method of claim 1 wherein at least one of the enhanced listings includes call-on-select code, the method further comprising:
g) accepting a user selection the enhanced listing, wherein a call between the user and a party associated with the enhanced listing is established responsive to the accepted user selection; and
h) providing a listing network promotional message to the party associated with the selected enhanced listing.

12. The computer-implemented method of claim 11 wherein the listing network promotional message identifies an entity that determined the set of one or more enhanced listings.

13. The computer-implemented method of claim 1 wherein the call is established by the listing serving entity.

14. The computer-implemented method of claim 1 wherein the call is established by an affiliate of the listing serving entity.

15. A computer-implemented method comprising:
a) serving sets of one or more enhanced listings and one or more non-enhanced listings to a client device, at least one of the non-enhanced listings including call-on-select code;
b) tracking servings of non-enhanced listings;
c) accepting user selections of the non-enhanced listings;
d) tracking the user selections of the non-enhanced listings, wherein calls between the users and parties associated with the non-enhanced listings are established, responsive to the accepted user selections;
e) determining, for one of the non-enhanced listing, performance information using at least tracked servings of the non-enhanced listing and the tracked user selections of the non-enhanced listing; and
f) providing a listing network promotional message to the party associated with the non-enhanced listing, wherein the listing network promotional message conveys the determined performance information to the party.

16. The computer-implemented method of claim 15 wherein the determined performance is a call-through rate.

17. A computer-implemented method comprising:
a) accepting a query from a client device;
b) determining a set of zero or more enhanced listings using at least information in the query;
c) determining a set of one or more non-enhanced listings using at least information in the query, at least one of the one or more non-enhanced listings including a special telephone number through which an listing serving entity or an affiliate of the listing serving entity might connect a calling user-end client device and a business-end client device of the business associated with the listing;
d) serving the determined sets of zero or more enhanced listings and one or more non-enhanced listings to the client device;
e) accepting an indication of a user-end client device call to the special telephone number, wherein a call between the user and a party associated with the non-enhanced listing is established responsive to the accepted user-end client device call; and
f) providing a listing network promotional message to the party associated with the selected non-enhanced listing.

18. The computer-implemented method of claim 17 wherein at least some of the enhanced listings includes a call-on-select function, and
wherein none of the non-enhanced listings includes a call-on-selected function.

19. A computer-implemented method comprising:
a) serving determined sets of zero or more enhanced listings and one or more non-enhanced listings to a client device;
b) accepting a user selection of one of the non-enhanced listings, wherein communications between the user and a party associated with the non-enhanced listing is established responsive to the accepted user selection; and
c) providing listing network promotional message to the party associated with the selected non-enhanced listing.

20. The computer-implemented method of claim 19 wherein the communications is established via telephone.

21. The computer-implemented method of claim 19 wherein the communications is established via text messaging.

22. Apparatus comprising:
a) means for accepting a query from a client device;
b) means for determining a set of zero or more enhanced listings using at least information in the query;
c) means for determining a set of one or more non-enhanced listings using at least information in the query, at least one of the one or more non-enhanced listings including call-on-select code;
d) means for serving the determined sets of zero or more enhanced listings and one or more non-enhanced listings to the client device;
e) means for accepting a user selection of one of the non-enhanced listings, wherein a call between the user and a party associated with the non-enhanced listing is established responsive to the accepted user selection; and
f) means for providing listing network promotional message to the party associated with the selected non-enhanced listing.

23. Apparatus comprising:
a) means for accepting a query from a client device;
b) means for determining a set of zero or more enhanced listings using at least information in the query;
c) means for determining a set of one or more non-enhanced listings using at least information in the query, at least one of the one or more non-enhanced listings including a special telephone number through which an listing serving entity or an affiliate of the listing serving entity might connect a calling user-end client device and a business-end client device of the business associated with the listing;
d) means for serving the determined sets of zero or more enhanced listings and one or more non-enhanced listings to the client device;
e) means for accepting an indication of a user-end client device call to the special telephone number, wherein a call between the user and a party associated with the non-enhanced listing is established responsive to the accepted user-end client device call; and
f) means for providing a listing network promotional message to the party associated with the selected non-enhanced listing.
